(19) United States
(12) Patent Application Publication
(10) Pub. No.: US 2024/0270609 A1
(43) Pub. Date: Aug. 15, 2024

(54) APPARATUS AND PROCESS FOR CONVERTING AMMONIA FROM AN AMMONIA-CONTAINING AQUEOUS SOLUTION TO MOLECULAR NITROGEN

(71) Applicant: Jassen-Kunststoffzentrum GmbH-- Apparaebau, Zuschnitte und Formung, Steinen (DE)

(72) Inventors: Marco ILLENBERGER, Freiburg (DE); Bernhard ILLENBERGER, Steinen (DE); Hartmut JASSEN, Steinen (DE)

(73) Assignee: Jassen-Kunststoffzentrum GmbH-- Apparaebau, Zuschnitte und Formung, Steinen (DE)

(21) Appl. No.: 18/567,861

(22) PCT Filed: Jun. 8, 2022
(86) PCT No.: PCT/EP2022/065520

§ 371 Date: Mar. 8, 2024

(30) Foreign Application Priority Data
Jun. 8, 2021 (DE) 10 2021 114 704.2

(51) Int. Cl. C02F 1/461; C01B 3/04; C01B 13/02; C02F 1/72; C02F 101/16

(52) U.S. Cl. CPC C02F 1/46176; C01B 3/047; C01B 13/0214; C02F 1/722; C02F 1/725; C02F 2101/16; C02F 2209/06; C02F 2209/14; C02F 2209/22; C02F 2301/046

(57) ABSTRACT

An apparatus (1) and a process for converting ammonia from an ammonia-containing aqueous solution (2) into molecular nitrogen. The apparatus (1) is constructed so that the solution (2) can circulate in a circuit (3) and in this case can be guided repeatedly through the apparatus (1).

### CROSS-REFERENCE TO RELATED APPLICATIONS

This application is a 371 National Phase of PCT/EP2022/065520, filed Jun. 8, 2022, which claims priority from German Patent Application No. 10 2021 114 704.2, filed Jun. 8, 2021, both of which are incorporated herein by reference as if fully set forth.

### TECHNICAL FIELD

The invention relates to an apparatus and a process for converting ammonia from an ammonia-containing aqueous solution into molecular nitrogen.

### BACKGROUND

Ammonia-containing aqueous solutions, in which the ammonia is only present in low concentration, are ubiquitous.

Such solutions originate, for example, from organic wastes such as household wastewater, sewage sludge, or fermentation products which arise, for example, in biogas plants.

Presently, the ammonia is either left in the waste product or is withdrawn therefrom with significant energy consumption in practice in the case of organic wastes.

Fermentation products are thus presently often distributed onto agricultural land, without reducing the ammonia proportion, so that the ammonia reaches the soil directly, where the nitrification process of ammonia to nitrate and the denitrification process of nitrate to molecular nitrogen takes place naturally.

Simulating this natural process of nitrification and denitrification by cultivating suitable bacteria is known from sewage treatment plants. Large amounts of oxygen are required for the nitrification, for the production of which a large amount of energy has to be applied. The microbial process moreover may only be controlled with difficulty.

### SUMMARY

The invention is based on the object of converting the ammonia from an aqueous, impure solution having a low ammonia concentration in a controlled and efficient manner and bringing it to a desired value in the most environmentally friendly manner possible.

A fermentation product can contain, for example, approximately 800 mg of ammonia in a liter of solution. A value of 150 mg/L can be desired, for example. Such an ammonia concentration can be optimal, for example, for producing a fertilizer in a bioreactor.

The invention provides one or more of the features disclosed herein to achieve this object. It is therefore proposed in particular according to the invention in an apparatus of the type described at the outset to achieve the mentioned object that the apparatus has units for circulating the solution in a circuit, an inlet for supplying the solution into the circuit, and a removal opening for removing the solution from the circuit. The units of the circuit comprise a cathode chamber, which has a cathode. The units furthermore comprise an anode chamber for converting the ammonia into molecular nitrogen, wherein the anode chamber has an anode. The proposal provides that the anode chamber has a supply line for the circulating solution, wherein the anode chamber has a passage for the circulating solution into the cathode chamber, and wherein the cathode chamber has a discharge line for the circulating solution, which is connected to the supply line of the anode chamber via a pump for pumping the circulating solution.

An apparatus is therefore provided in which an anode chamber and a cathode chamber belong to a common circuit. The solution can be conducted continuously and multiple times through anode chamber and cathode chamber here. This enables a continuous, environmentally-friendly, and controlled ammonia conversion even at a low ammonia starting concentration and above all at a low final ammonia target concentration, wherein moreover electrical energy is generated during the ammonia conversion.

It is thus not possible or only possible with very high energy consumption in the bacterial conversion carried out in the sewage treatment plants to achieve a conversion down to low ammonia concentrations of, for example, less than 10 mg/L. Low ammonia concentrations in this range are often required, however. In contrast, such low ammonia concentrations can be achieved easily with the apparatus according to the invention. The time expenditure does increase somewhat if a very low ammonia concentration is to be achieved. However, measurements have shown that very low ammonia concentrations, even of less than 1 mg/L, can be achieved within hours or a few days and that energy is even generated in this case.

The anode chamber is designed to convert ammonia into nitrogen in operation. The cathode chamber can be designed to emit the electrons coming from the anode to the cathode in operation to the solution with chemical participation of protons, oxygen, and/or hydrogen peroxide located in the solution, which can be converted into water molecules.

To enable an electron flow from the anode to the cathode, it can be provided that the anode and the cathode are electrically connected to one another. To be able to use the resulting electrical energy, it can be provided that a load is arranged in the electrical connection between the anode and the cathode.

The cathode chamber preferably has two electrodes on opposite sides of the cathode chamber. The two electrodes can be electrically connected to one another.

The removal opening can be closable. The removal opening can be provided, for example, by a connection which can be closable using a valve. The removal opening can also be provided, for example, by the access to a container open on top. The cathode chamber can thus have a container which can be closable on top using a cover. The solution can then be removed, for example, via a hose insertable into the container. Since the solution circulates in a circuit, the removal opening can in principle be formed at any arbitrary point of the circuit.

The inlet can also in principle be formed at any point of the circuit. However, the inlet is preferably connected or formed on the supply line of the anode chamber. This can be useful in particular for initializing the apparatus or if the circulation is temporarily interrupted, for example, to supply hydrogen peroxide or another substance which is initially supposed to flow into the anode chamber.

It can also be provided that the inlet forms the removal opening at the same time.

The supply line and the passage of the anode chamber are units of the circuit. The circulating solution flows through them in operation.

The cathode chamber and/or the anode chamber preferably each comprise at least one solution-tight container.

A first tank can be connected to an inlet using which a fluid can be added to the circuit, for example to the above-mentioned inlet. The first tank can be filled with the ammonia-containing aqueous solution.

A second tank can be connected to an inlet, using which a fluid can be added to the circuit, for example, to the above-mentioned inlet. The second tank can be filled with hydrogen peroxide.

In one advantageous embodiment, it can be provided that the passage of the anode chamber has a valve, using which it is openable and closable. The valve is preferably formed on or in the passage. The valve offers the option of interrupting the solution circuit. This can be advantageous, for example, during the initialization of the apparatus or in other situations in which a normal circulation of the solution is to be interrupted or in which a discharge of a substance located in the anode chamber into the cathode chamber through the passage is undesired.

In a further advantageous embodiment of the apparatus according to the invention, it can be provided that the anode chamber is arranged inside the cathode chamber. Such an arrangement offers a variety of options. In this way, a content of the anode chamber can be discharged easily into the cathode chamber. This can take place through the passage or another outlet. In particular, another outlet can thus be arranged close to the cathode arranged in the cathode chamber. As will be explained in more detail at another point, this can be advantageous since in this way hydrogen peroxide and/or oxygen can be brought directly to the cathode, which can increase the ammonia conversion.

In a further advantageous embodiment, it can be provided that the anode chamber has, in addition to the passage, at least one further outlet into the cathode chamber. Preferably, each anode chamber module has a separate outlet into the cathode chamber. The at least one further outlet is preferably dimensioned so that an amount of the solution flowing through the passage into the cathode chamber exceeds a total amount of the solution flowing through the at least one further outlet. The at least one further outlet is particularly preferably dimensioned so that the amount of the solution flowing through the passage into the cathode chamber exceeds the entire amount of the solution flowing through the at least one further outlet by multiple times, for example, more than fivefold, more than tenfold, more than 20-fold, more than 50-fold, or even more than 100-fold.

The at least one outlet is preferably dimensioned so that in normal operation the circulation of the solution is not disturbed by a leak from the at least one outlet. A minor leak from the at least one outlet, by which the efficiency is not noticeably influenced, does not disturb the circulation of the solution.

Dimensioning of the at least one outlet can be performed in particular by suitable dimensioning of the radii and lengths of the outlets.

If only one anode container is formed having one outlet and one passage, a larger amount thus flows through the passage if its flow resistance is lower than the flow resistance of the outlet.

For example, the diameter of the at least one outlet can be narrower than 1 mm or can be between 0.3 mm and 0.8 mm.

The additional outlet can be advantageous in particular during the initialization of the apparatus. This will be described in more detail at another point.

In a further advantageous embodiment, it can be provided that a catalyst for catalytic splitting of hydrogen peroxide, preferably into molecular oxygen and water, is arranged in the anode chamber. The catalyst is preferably manganese dioxide. Using such embodiments, oxygen can be generated in the anode chamber, which can then be brought into the cathode chamber and as close as possible to the cathode there. Since hydrogen peroxide is liquid, in contrast to molecular oxygen, even small amounts are sufficient to provide large amounts of oxygen. A controlled conversion of the hydrogen peroxide in the anode chamber can take place well in particular if the anode chamber is not completely filled with a or the solution, while the cathode chamber can be completely filled with the solution.

In a further advantageous embodiment, it can be provided that a material of the cathode is a catalyst for catalytic splitting of hydrogen peroxide into molecular oxygen and water. The material of the cathode is preferably manganese dioxide. These embodiments have the advantage that the oxygen availability at the cathode is improved. A high oxygen availability at the cathode increases the efficiency in the case of solutions having low ammonia concentration. In this case, only a few electrodes travel from the anode to the cathode, so that it is more difficult for them to come into contact with oxygen at the cathode. A high oxygen availability increases the chance of a contact of an electron with an oxygen molecule.

The effect is based on the finding that the oxygen molecules located in the cathode chamber initially form hydrogen peroxide molecules as an intermediate product by means of absorbing cathode electrons, which are then reduced by absorbing further electrons and free protons to form water molecules. The back formation of oxygen, which can also be designated as recycling of oxygen, therefore inhibits the neutralization of a free proton with a free electron in favor of an increase of the density of oxygen molecules at the cathode, which increases the chance that a newly arriving electron will find a reaction partner at the cathode. This therefore has a positive effect on the electron flow from the anode to the cathode, which also improves the conversion at the anode.

A material of the anode is preferably zinc. Zinc promotes the conversion of ammonia to molecular nitrogen in the anode chamber in a particularly efficient manner.

In a further advantageous embodiment of the apparatus, it can be provided that the anode chamber comprises more than one anode chamber module, wherein the anode chamber modules are connected to one another in series in the circuit. Connected in series in the circuit means that in operation the solution flows through the anode chamber modules one after another from a first to a last before it flows through the first anode chamber module again. The solution therefore passes through the anode chamber modules in succession in operation.

This can take place, for example, in that the supply line of the anode chamber is connected to an inlet of a first anode chamber module, in that the first anode chamber module has a discharge line which is connected to an inlet of a second anode chamber module, wherein the second anode chamber module in turn has a discharge line, which is connected to an inlet of a next anode chamber module, wherein such connections are continued up to a last anode chamber module which has a passage which forms the passage of the anode chamber into the cathode chamber.

The anode chamber modules can also be designed identically, wherein then the above-described discharge lines correspond to the passage of the last anode chamber module. The series connection has the advantage, among other things, that a larger area of anode material is reachable, so that the conversion of the ammonia is improved. The modularity furthermore has the advantage that by adapting the number of anode chamber modules, the conversion rate of ammonia to molecular nitrogen is adaptable.

An anode chamber module can comprise, for example, an anode container. An anode chamber module can alternatively also be a pipe section. Multiple anode chamber modules can thus be connected one behind another in the latter case in that the pipe sections are connected to one another, for example, using flanges.

The anodes of the anode chamber modules connected in series are preferably at an equal electrical potential. This can be achieved, for example, by an electrical parallel connection of the anodes.

In a further advantageous embodiment, it can be provided that a supply line is formed in direct proximity to the cathode. In this way, it is possible to cause hydrogen peroxide or molecular oxygen to be brought immediately and directly to the cathode when the cathode chamber is filled with the solution in operation. The supply line is preferably provided by an outlet of the anode chamber, preferably by the above-mentioned outlet of the anode chamber, which has an increased flow resistance. The supply line can, however, also extend directly into the cathode chamber and can be arranged directly therein with suitable openings in the immediate vicinity of the cathode. These embodiments have the advantage that the oxygen availability at the cathode can be increased. Hydrogen peroxide and/or molecular oxygen are brought immediately and directly to the cathode if they do not reach the cathode first via diffusion, but rather if they are conducted directly to the cathode as a result of flowing out of the supply line.

In a further advantageous refinement of the apparatus according to the invention, it can be provided that a measuring sensor is arranged so that a property of the solution is measurable using it in operation. The property is preferably an oxygen concentration, a pH value, and/or an ammonia concentration. The measuring sensor can in principle be arranged at any point of the circuit through which the circulating solution flows in operation. The measuring sensor is preferably arranged in the cathode chamber. Multiple measuring sensors can also be provided.

To be able to synthesize hydrogen peroxide and/or molecular oxygen in an environmentally friendly manner for the running operation of the apparatus and thus further increase the efficiency of the ammonia conversion, it can be provided in a further advantageous embodiment of the apparatus that an oxygen-generating unit is connected to the circuit, wherein the oxygen-generating unit comprises a photocell. An arrangement made up of the apparatus according to the invention for converting ammonia from an ammonia-containing aqueous solution into molecular nitrogen and an oxygen-generating unit is created in this way, wherein the oxygen-generating unit comprising the photocell is connected to the circuit. The photocell preferably has a hollow body having a transparent wall. The photocell is particularly preferably transparent in visible light and/or in the spectrum of sunlight. Furthermore, a large number of photosensitive particles are preferably suspended in a photocell solution containing water in the photocell. A photosensitive particle preferably has a carrier element, to which a material adheres by means of an adhesive, wherein the material contains light-active pigment molecules.

The material particularly preferably contains plant leaf polymers of dead and dropped autumn leaves.

The light-active pigment molecules can be excited by corresponding irradiated light. This can have the result that electrons and protons are transferred to neighboring molecules. If the neighboring molecule is molecular oxygen, this can have the result that hydrogen peroxide is formed. If the pigment molecules are incorporated in a humic substance-clay mineral complex, radicals can be generated. For example, a radical generated as a hyperoxide anion can trigger a proton transfer to a transition metal such as iron or copper, which are incorporated in the humic substance-clay mineral complex, by which molecular oxygen can be split off from the humic substance-clay mineral complex, which can then be converted into hydrogen peroxide. As a result, with the aid of the photocell, hydrogen peroxide and oxygen dissolved in water can be generated.

The photocell is preferably sensitive in visible light, in particular in the spectrum of sunlight. A corresponding artificial light source can be designed. Alternatively, the sun can be used as a light source.

The photocell is preferably integrated in a separate oxygen-generating circuit for the photocell solution. A pump can be arranged in the oxygen-generating circuit. The pump can cause the required drive for the circulation of the photocell solution in the oxygen-generating circuit. A water tank can be formed, using which water can be supplied into the oxygen-generating circuit.

The oxygen-generating unit can have a supply line to the circuit of the ammonia-containing solution, so that hydrogen peroxide and/or oxygen can be introduced into the circuit. The supply line can be connected, for example, to the inlet mentioned at the outset.

The carrier element preferably has a maximum diameter of 1 cm, more preferably between 100 μm and 0.5 cm, particularly preferably between 0.5 mm and 3 mm, very particularly preferably between 1 mm and 2 mm.

The carrier element can have any shape in principle, a spherical shape is preferred.

The carrier element is preferably made of a plastic. The carrier element is preferably a microplastic particle. The microplastic particle can be manufactured from primary or secondary plastic.

It can be provided that the adhesive comprises a mucilage. The mucilage preferably contains a polysaccharide. The mucilage can be a mucin. The mucilage can be human, animal, or plant mucus. The mucilage can also be a saliva substitute product such as hyaluronic acid.

It is preferably provided that the adhesive envelops the carrier element.

The material can comprise a nonliving, in particular dead organic substance. The material can in particular comprise a humus component and/or a clay mineral. The humus component is preferably a humic substance. Clay minerals can form particularly advantageous complexes with humic substances.

A clay mineral is preferably a mineral having an average grain size less than 5 μm, preferably less than 2 μm.

Humus can have a high density of light-active pigment molecules in suitable layers. Layers in which the humus additionally has a high proportion of lignin and polyphenol fragments and light-active pigment molecules integrated therein are suitable for the invention.

It has proven to be particularly advantageous if the material comprises plant leaf polymers. The plant leaf polymer of the aged, in particular shed in the autumn months of September and October, dropped, and dead leaves of deciduous trees form a particularly advantageous structure. The plant leaf polymer of plants in the plant family dicotyledonous angiosperms is particularly advantageous, in particular having a cellulose proportion of 15-50%, hemicellulose proportion of 3-50%, and/or lignin proportion of 7-10%. The plant leaf polymer of the dead leaves of deciduous trees can have a high concentration of different pigment molecules.

The material which contains the light-active pigment molecules can be obtained, for example, by isolating and/or providing nonliving, in particular dead, organic substance. Plant leaf polymer, preferably from autumn leaves or from leaves as described above is preferably provided. The provision of the plant leaf polymer or the plant leaf material containing the plant leaf polymer can take place in completely or partially dried form. Its plant pigment proportion is particularly preferably at least 1% and/or its lignin mass proportion is greater than 1% in dry substance and/or its mass proportion of a chlorophyll degradation product non-fluorescent chlorophyll catabolites (NCC) is between 0.6% to 1.2% in dry substance of the total proportion of the plant leaf material.

The plant leaf material, in particular the dried and/or pulverized plant leaf material, is preferably mixed with clay minerals. The mass proportion of the plant leaf material is preferably between 60% and 99%, the mass proportion of the clay minerals is between 1% and 20%, and the mass proportion of water and/or the mass proportion of a further material is between 0% and 20%. The mass proportions relate to the mixture, which has a mass proportion of 100%.

It can be provided that the material containing the light-active pigment molecules is mixed with the adhesive. The material preferably has a mass proportion between 80% and 99%, the adhesive has a mass proportion between 1% and 10%. Furthermore, water can be admixed with a mass proportion between 0% and 10%. Overall, the above-mentioned mass proportions are each related to a mass of the mixture, which has a mass proportion of 100%.

It can be provided that this material-adhesive mixture is then mixed with the carrier elements. The carrier elements can be enveloped by the adhesive in this way. The viscosity of the adhesive and/or the volume ratio of the carrier elements to the material-adhesive mixture are preferably adjusted during the mixing so that the outer surface of the envelope is at most 10%, preferably at most 5%, larger than the surface of the enveloped carrier element.

To achieve the mentioned object, according to the invention, the features of the alternative independent claim directed to a process for converting ammonia are provided. In particular, to achieve the mentioned object, it is therefore proposed according to the invention in a process for converting ammonia from an ammonia-containing aqueous solution into molecular nitrogen that an apparatus is used which is designed according to the invention, in particular as described above and/or according to one of the claims directed to an apparatus for converting ammonia from an ammonia-containing aqueous solution into molecular nitrogen, and that the solution circulating in the circuit is guided repeatedly through the apparatus. The repeated guiding of the solution through the apparatus enables the ammonia concentration in the solution to be reduced continuously and in a controlled manner to a desired concentration.

At the same time, electrical energy can be generated by the process. A voltage thus results between the anode and the cathode, which can be used to supply a load with energy or to charge an energy storage apparatus.

In order that the solution can circulate in the apparatus, it can be provided that a valve, using which the passage is closable, is open. The valve can be the above-mentioned valve, for example.

It can be provided that the solution has a low ammonia starting concentration.

In one advantageous embodiment of the process, it can be provided that for initialization, the cathode chamber is filled with the solution and that hydrogen peroxide and/or oxygen dissolved in water is introduced into the anode chamber via the supply line of the anode chamber. The initialization is preferably ended as soon as an initialization oxygen concentration threshold value is reached in the solution. The oxygen concentration can be measured using an oxygen concentration measuring sensor. The hydrogen peroxide introduced into the anode chamber enters the cathode chamber, so that the oxygen content in the solution is increased. The subsequently beginning conversion rate of the ammonia into molecular nitrogen can be significantly increased in this way.

The supply of the hydrogen peroxide and/or the dissolved oxygen preferably takes place before the ammonia-containing solution is introduced into the anode chamber. An optimum oxygen concentration can be set in the subsequently circulating solution even before regular operation in this way.

If a catalyst for catalytic splitting of hydrogen peroxide is arranged in the anode chamber, a large amount of molecular oxygen can be provided from a small amount of liquid hydrogen peroxide. Since the oxygen enters the gas phase, the pressure in the anode chamber thus increases and the oxygen gas can be pressed at high speed into the cathode chamber. The resulting gas flow can entrain liquid hydrogen peroxide in this case and also press it into the cathode chamber.

If the anode chamber has one or more outlets as described above, the oxygen can be brought close to the cathode thereby, where the oxygen can be recycled depending on the design of the cathode. The high oxygen concentration at the cathode thus resulting can have the result that in the subsequent normal operation, a maximum conversion of the ammonia is already reached after a few minutes, wherein reaching a maximum conversion rate can take multiple hours without corresponding initialization.

It is preferably provided that a valve at the passage of the anode chamber, for example, the above-mentioned valve, is closed for the initialization. In this way, the oxygen can be guided in a controlled manner into the cathode chamber through one or more outlets formed on the anode chamber.

It is preferably provided that with or after ending of the initialization, the valve is opened and the solution circuit is activated by switching on the pump, so that the solution is introduced via the supply line into the anode chamber.

In a further advantageous embodiment of the process, it can be provided that hydrogen peroxide and/or oxygen dissolved in water is added to the solution circulating in the circuit. Preferably, an oxygen concentration in the solution is measured and addition takes place when it falls below a lower oxygen concentration threshold value. A valve formed at the passage preferably remains open in this case. In this way, in normal operation, in which the solution circulates, the oxygen saturation in the solution can always be high enough to achieve an optimum conversion rate of the ammonia.

It is preferably provided that the hydrogen peroxide and/or the oxygen dissolved in water is supplied from an oxygen-generating unit as described above.

In a further embodiment of the process, it can be provided that an ammonium and/or ammonia concentration is measured and that if it falls below a lower ammonium and/or ammonia concentration threshold value, all of the solution or a part of it is removed from the circuit. This preferably takes place via the removal opening.

It can be provided that the apparatus is operated so that the solution is always completely exchanged. Alternatively, it can be provided that still untreated solution is added step-by-step or continuously and then is completely removed after reaching a sufficiently low ammonium and/or ammonia concentration.

A completely continuous operation is also possible, in which the solution is removed at a constant rate. Under ideal conditions and/or optimum process control, an equilibrium can then result for the ammonia concentration in the circulating solution, wherein the concentration is adjustable by controlling the removal rate.

### BRIEF DESCRIPTION OF THE DRAWINGS

The invention will now be described in more detail on the basis of a few exemplary embodiments, but is not restricted to these few exemplary embodiments. Further variants of the invention and exemplary embodiments result by combining the features of individual or several claims with one another and/or with individual or several features of the exemplary embodiments and/or the above-described variants of apparatuses and processes according to the invention.

In the figures:

FIG. 1 shows a cathode chamber having anode chamber modules arranged therein of the exemplary embodiment, which is completely illustrated in FIG. 2 and FIG. 3, of an apparatus according to the invention for converting ammonia from an ammonia-containing aqueous solution into molecular nitrogen,

FIG. 2 shows an exemplary embodiment of an apparatus designed according to the invention for converting ammonia from an ammonia-containing aqueous solution, which is currently being initialized for regular operation,

FIG. 3 shows the apparatus according to FIG. 2 in normal operation,

FIG. 4 shows an alternative exemplary embodiment of an apparatus designed according to the invention having an oxygen-generating unit, and

FIG. 5 shows a photosensitive particle for an oxygen-generating unit according to FIG. 4.

### DETAILED DESCRIPTION

In the following description of various exemplary embodiments of the invention, elements corresponding in their function receive corresponding reference numbers even if the design or shape differs.

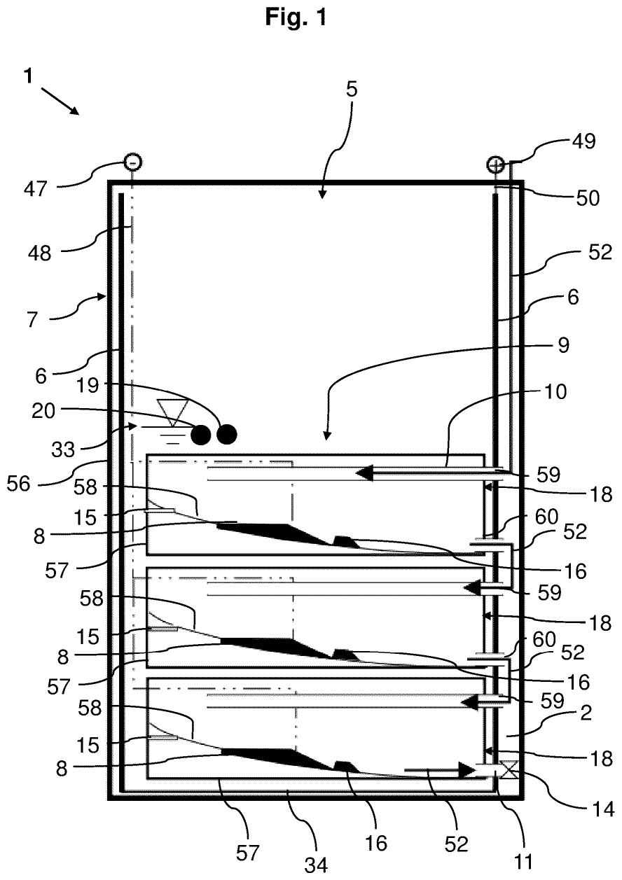

FIG. 1 to FIG. 3 show a first exemplary embodiment of an apparatus 1 designed according to the invention for converting ammonia from an ammonia-containing aqueous solution 2 into molecular nitrogen. The solution can be a residue solution, such as a fermentation product from a biogas plant, the solid components of which have been largely separated.

The apparatus 1 comprises a cathode chamber 7. The cathode chamber 7 has a container 56 having an opaque wall. The container 56 can be provided on top with a removable cover, so that a removal opening 5 for removing solution 2 located in the container 56 can be formed on top.

Additionally or alternatively, in an alternative exemplary embodiment, a removal opening 5 can also be formed on the container 56 in that it has a drain, which can be closable using a valve.

A cathode 6 having manganese dioxide as the cathode material is arranged in each case on both sides of the container 56 in the cathode chamber 7. The cathodes 6 are electrically connected to one another via an electrical connection 34.

The anode chamber 9 is arranged inside the cathode chamber 7, in particular inside the container 56 of the cathode chamber 7. The anode chamber 9 has multiple anode chamber modules 18 which are connected to one another in series. The anode chamber modules 18 each have a container 57 having an opaque wall. For the series connection, each anode chamber module 18, and in particular each container 57, has an inlet 18 and a discharge line 60. The discharge line 60 is connected to the inlet 59 of the respective closest anode chamber module 18 via a line.

A supply line 10 is connected to an inlet 59 of the first anode chamber module 18, so that solution 2 can be conducted into the anode chamber 9. The discharge line 60 of the last anode chamber module 18 forms a passage 11 into the cathode chamber 7. Solution 2 which is conducted via the supply line 10 into the anode chamber 9 therefore passes the individual anode chamber modules 18 in succession and enters the cathode chamber 7 at the passage 11 of the anode chamber 9.

The cathode chamber 7 is filled with the solution 2 up to a fill level 33. The cathode chamber 7 has a discharge line 12, via which the solution introduced from the anode chamber 9 into the cathode chamber 7 can be discharged again.

The discharge line 12 has a line connection via a pump 13 to the access 10 of the anode chamber 9, so that the solution 2 can circulate in a circuit 3. A solution flow 52 forming is shown in the drawings. The arrows indicate the flow direction. The pump 13 pumps the solution 2 out of the cathode chamber 7 and into the anode chamber 9. The solution 2 flows through the passage 11 back into the cathode chamber 7, where it is again pumped by the pump 13 into the anode chamber 9. When the valve 14 is open at the passage 11, a solution circuit thus results, in which the solution 2 repeatedly passes through the apparatus 1. The pump 13, but also the further above-mentioned components, which enable a solution circuit as described above, such as the cathode chamber and the anode chamber 7, 9, the supply line and discharge line 10, 12, the passage 11, or also the valve 14 form units for the circulation of the solution in the circuit.

An anode 8 is arranged in each of the anode chamber modules 18. Zinc is provided as the anode material. If the solution 2 containing ammonia passes along the anodes 8, the ammonia reacts with hydroxide ions and forms water and molecular nitrogen. In addition, electrons are released which travel to the cathode 6, which is electrically connected to the anodes 8, which are electrically connected in parallel, via electrical lines 48, 50. Electrons can then react with molecular oxygen dissolved in the solution 2 on the cathode 6 and water can be formed by the absorption of free protons.

The reactions on the anodes 8 and cathodes 6 thus result in a potential difference between anode 8 and cathode 6, so that electrical energy can be generated. A load 51 can be supplied with electrical energy using the generated electrical energy. The anode 8 forms a negative pole 47 here, while the cathode forms the positive pole 49.

Measuring sensors 19, 20, which are immersed in the solution 2, are arranged in the cathode chamber 7. The measuring sensors 19 can be, for example, a measuring sensor 19, using which an oxygen concentration can be measured in the solution 2. The measuring sensor 20 can be, for example, a measuring sensor 20, using which an ammonia concentration in the solution 2 can be measured.

The anode chamber modules 18, in particular their containers 57, each have an outlet 15 opposite the access 10 and the passage 11. The outlets 15 are dimensioned in such a way, in particular dimensioned sufficiently narrow, that in regular operation the amount of solution flowing through the passage 11 into the cathode chamber 7 is multiple times greater than the total amount of solution 2 which flows through all outlets 15 into the cathode chamber 7. The outlet 15 is arranged farther upward in an anode container 57 than the respective discharge line 60. The outlets 15 are arranged directly at the cathode 6, so that hydrogen peroxide or molecular oxygen, which flows through an outlet 15, can reach the cathode 6 immediately and directly.

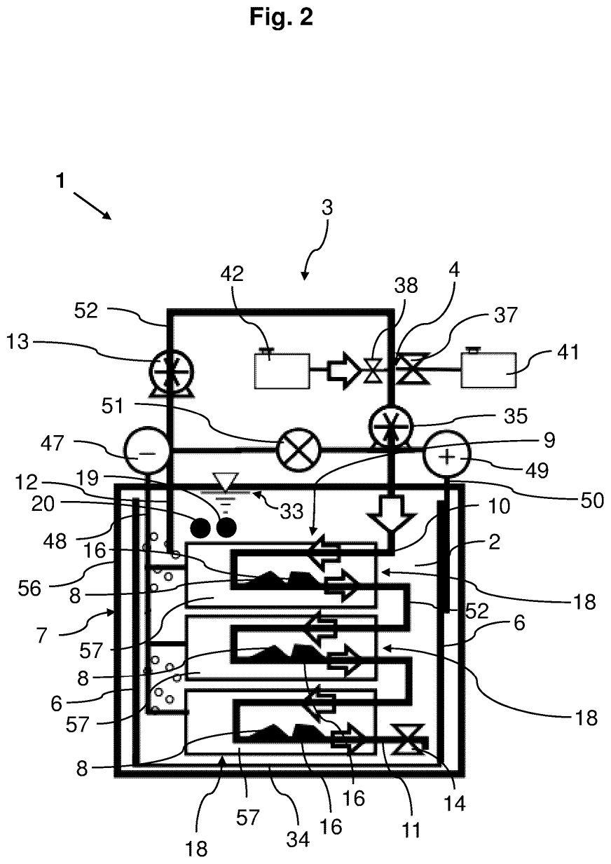

The outlets 15 are important above all during the initialization of the apparatus 1, which has already been described in more detail above and is illustrated in FIG. 2. It is shown therein that the apparatus 1 has an inlet 4, using which the solution 2 can be added to the circuit 3. A tank 41 is filled with the solution 2, which has an ammonia starting concentration of, for example, 800 mg/L. The tank 41 has a line connection to the inlet 4, wherein the supply line is closable by a valve 37. For the initialization of the apparatus 1, the cathode chamber 7 is filled up to the fill level 33 with valve 37 open. The valve 37 is then closed.

A further tank 42 is filled with hydrogen peroxide. The tank 42 has a line connection to the inlet 4 via a valve 38. This valve 38 is initially closed. After filling the cathode chamber 7 with the solution 2, the valve 14 is closed and the valve 38 is opened, so that hydrogen peroxide flows via the inlet 4 and the supply line 10 initially into the first anode chamber module 18 of the anode chamber 9 by means of switched-on pump 35. A contact surface of a catalyst 16 made of manganese dioxide is located on an inclined intermediate floor 58 in each anode chamber module 18. The hydrogen peroxide is catalytically converted into molecular oxygen by the manganese dioxide. The volume increases very strongly here, since hydrogen peroxide is liquid and molecular oxygen is gaseous. The pressure in the anode chamber module 18 rises and oxygen is pressed out of the outlet 15 and conducted to the cathode 6. Hydrogen peroxide can also be entrained in this case and in this way reaches the cathode 6 directly via the outlet 15. The oxygen content in the solution 2 can be measured using the oxygen concentration measuring sensor 19. A desired concentration is soon reached. If this concentration is reached, the initialization phase is completed and the apparatus 1 can be operated in the regular operating mode.

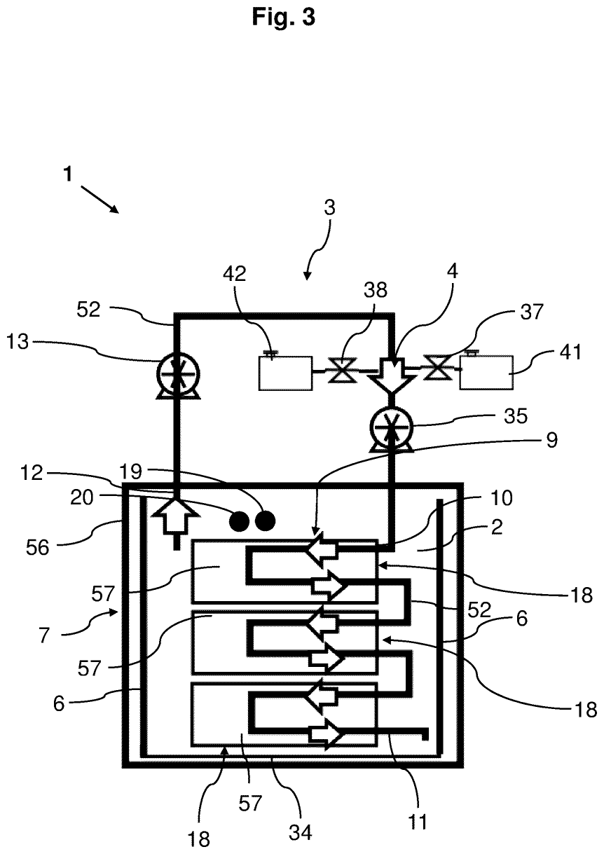

The regular operating mode is described in more detail above and illustrated in FIG. 3. The valves 37, 38 are or will be closed, the valve 14 is open. The pump 13 is activated so that the solution 2 begins to form a solution flow 52 and to circulate through the apparatus 1 in the circuit 3. The reactions at anode 8 and cathode 6 begin. The high initial oxygen concentration at the cathode 6 and the oxygen recycling due to the manganese dioxide used as the cathode material have the result that the ammonia conversion rate rapidly reaches a high operating value. The molecular nitrogen formed can escape upwards through a venting option in the cathode chamber 7 into the atmosphere or can be collected in another way, for example.

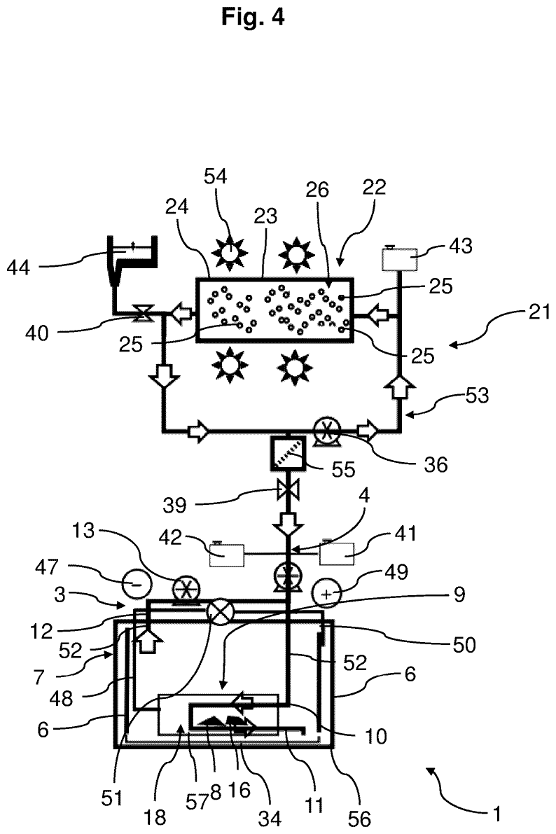

The oxygen concentration can be checked by means of the sensor 19 in regular operation. If it sinks below a critical value, the valve 38 can be opened, so that hydrogen peroxide is added to the further circulating solution 2 via the inlet 4. Alternatively, hydrogen peroxide and molecular oxygen dissolved in water can also be added via an oxygen-generating unit 21 via the inlet 4 to the circulating solution 2, cf. the exemplary embodiment described next according to FIG. 4.

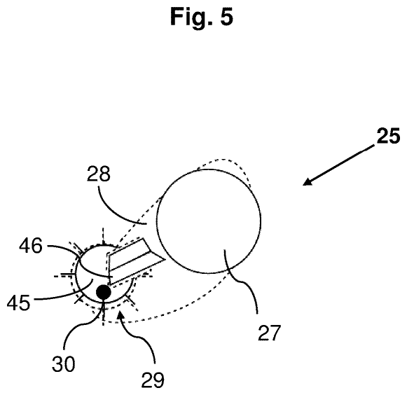

FIG. 4 shows a second exemplary embodiment of an apparatus 1 designed according to the invention for converting ammonia from an ammonia-containing aqueous solution 2 into molecular nitrogen having an oxygen-generating unit 21, which comprises a photocell 22 having photosensitive particles 25, one of which is schematically shown in FIG. 5. The apparatus 1 is designed in principle like the apparatus 1 shown in FIG. 1 to FIG. 3. However, the anode chamber 9 only has a single anode container 57. Moreover, an oxygen-generating unit 21 is additionally provided. Such a unit can be used independently of how many anode chamber modules 18 or anode containers 57 the anode chamber 9 has.

The oxygen-generating unit 21 has a line connection to the inlet 4 via a filter 55 and a valve 39, so that solution from the oxygen-generating unit 21 can be introduced into the circuit 3.

The oxygen-generating unit 21 has a photocell 22 having a hollow body 23, which has a wall 24 transparent to light in the spectrum of sunlight. A large number of photosensitive particles 25 are arranged in the hollow body 23.

One such photosensitive particle 25 is shown in FIG. 5. The particle 25 has a carrier element 27, which can be a microplastic particle. The carrier element 27 is surrounded by an adhesive 28, in which a material 29 is embedded that contains light-active pigment molecules 30. The light-active pigment molecules 30 are embedded in the exemplary embodiment shown in FIG. 5 in a complex made of humic substance 45 and clay mineral 46. Only one single complex 45, 46 and one light-active pigment molecule 30 are explicitly shown greatly enlarged and schematically in the figure. In reality, a very large number of humic substance molecules, clay mineral particles, and pigment molecules 30 are present. If such a photosensitive particle 25 is suspended in a photocell solution 26, which can be water, an excitation of the light-active pigment molecules 30 can have the result that radicals form which release oxygen from the humic substance-clay mineral complex. Furthermore, the excitation of the pigment molecules 30 can have the result that the released oxygen is converted into hydrogen peroxide or that molecular oxygen is dissolved in the photocell solution 26.

The photocell 22 is integrated in an oxygen-generating circuit 53. The photocell solution 26 can be set into circulation by means of a pump 36 and a line system which forms a circuit. Photocell solution 26 enriched with hydrogen peroxide and/or molecular oxygen can be added via the valve 39 to the circulating, ammonia-containing solution or can be introduced directly into the anode chamber 9. The absent photocell solution 26 can be replaced by means of a tank 44, connected via a valve 40, which is filled with photocell solution 26, preferably with water. Excess photocell solution 26 enriched with hydrogen peroxide and with oxygen can alternatively also be guided into a tank 43 for later use and temporarily stored there. Sunlight can be used as a light source 54. Alternatively, an artificial light source 54 can also be used, which generates light in a wavelength range suitable for the photocell 22.

Further variants of the oxygen-generating unit 21 and the photosensitive particles 25 and processes for producing the photosensitive particles 25 have been described above in detail.

The invention relates to an apparatus 1 and a process for converting ammonia from an ammonia-containing aqueous solution 2 into molecular nitrogen. The apparatus 1 is constructed so that the solution 2 can circulate in a circuit 3 and can be guided repeatedly through the apparatus 1 in this case.

### LIST OF REFERENCE SIGNS

1 apparatus
2 solution
3 circuit
4 inlet
5 removal opening
6 cathode
7 cathode chamber
8 anode
9 anode chamber
10 supply line
11 passage
12 discharge line
13 pump
14 valve
15 outlet
16 catalyst
18 anode chamber module
19 measuring sensor
20 further measuring sensor
21 oxygen-generating unit
22 photocell
23 hollow body
24 wall
25 photosensitive particle
26 photocell solution
27 carrier element
28 adhesive
29 material
30 light-active pigment molecules
33 fill level
34 electrical connection
35 further pump
36 further pump
37 further valve
38 further valve
39 further valve
40 further valve
41 tank
42 further tank
43 further tank
44 further tank
45 humic substance
46 clay mineral
47 negative pole
48 electric line
49 positive pole
50 further electric line
51 load
52 solution flow in 3
53 oxygen-generating circuit
54 light source
55 filter
56 container of 7
57 container of 18
58 intermediate floor in 57
59 inlet of 18
60 discharge line of 18

1. An apparatus for converting ammonia from an ammonia-containing aqueous solution into molecular nitrogen, the apparatus comprising:
units for circulating the solution in a circuit, having an inlet for adding the solution into the circuit, and having a removal opening for removing the solution from the circuit, the units of the circuit comprise:
a cathode chamber having a cathode and an anode chamber having an anode for converting the ammonia into molecular nitrogen,
the anode chamber has a supply line for the circulating solution,
the anode chamber has a passage for the circulating solution into the cathode chamber, and
the cathode chamber has a discharge line for the circulating solution, which is connected to the supply line of the anode chamber via a pump for pumping the circulating solution.

2. The apparatus as claimed in claim 1, wherein the passage of the anode chamber has a valve by which the passage is openable and closable.

3. The apparatus as claimed in claim 1, wherein the anode chamber is arranged inside the cathode chamber.

4. The apparatus as claimed in claim 1, wherein the anode chamber has, in addition to the passage, at least one further outlet into the cathode chamber, and the at least one further outlet is dimensioned so that an amount of the solution flowing through the passage into the cathode chamber exceeds a total amount of the solution flowing through the at least one further outlet.

5. The apparatus as claimed in claim 1, further comprising a catalyst for catalytic splitting of hydrogen peroxide arranged in the anode chamber.

6. The apparatus as claimed in claim 1, wherein a material of the cathode is a catalyst for catalytic splitting of hydrogen peroxide into molecular oxygen and water.

7. The apparatus as claimed in claim 1, wherein the anode chamber comprises more than one anode chamber module, and the anode chamber modules are connected to one another in series in the circuit, so that the solution flows through the anode chamber modules in succession.

8. The apparatus as claimed in claim 1, further comprising a supply line formed in direct proximity to the cathode to bring hydrogen peroxide or molecular oxygen immediately and directly to the cathode when the cathode chamber is filled with the solution in operation.

9. The apparatus as claimed in claim 1, further comprising a measuring sensor arranged to measure a property of the solution in operation.

10. An arrangement comprising the apparatus as claimed in claim 1 and an oxygen-generating unit, wherein the oxygen-generating unit is connected to the circuit, the oxygen-generating unit comprises a photocell that has a hollow body having a transparent wall and a large number of photosensitive particles are suspended in a photocell solution containing water in the photocell, wherein each said photosensitive particle has a carrier element, on which a material adheres by an adhesive, and the material contains light-active pigment molecules.

11. A process for converting ammonia from an ammonia-containing aqueous solution into molecular nitrogen using the apparatus as claimed in claim 1, the process comprising:
circulating the solution in the circuit repeatedly through the apparatus.

12. The process as claimed in the claim 11, further comprising, for initialization, filling the cathode chamber with the solution and introducing at least one of hydrogen peroxide or oxygen dissolved in water into the anode chamber via the supply line of the anode chamber, and ending the initialization as soon as an initialization oxygen concentration threshold value is reached in the solution.

13. The process as claimed in claim 12, wherein the at least one of the hydrogen peroxide or oxygen dissolved in water is added to the solution circulating in the circuit, and an oxygen concentration in the solution is measured and an addition takes place if the oxygen concentration falls below a lower oxygen concentration threshold value.

14. The process as claimed in claim 13, further comprising measuring at least one of an ammonium or ammonia concentration and if the at least one of the ammonium or ammonia concentration falls below a lower ammonium and/or ammonia concentration threshold value, removing at least some of all of the solution from the circuit.

15. The apparatus as claimed in claim 5, wherein the catalyst is manganese dioxide.

16. The apparatus as claimed in claim 6, wherein the material of the cathode is manganese dioxide.

17. The apparatus as claimed in claim 7, wherein anodes of the anode chamber modules are at an equal electrical potential.

18. The apparatus as claimed in claim 8, wherein the supply line is provided by an outlet of the anode chamber.

19. The apparatus as claimed in claim 9, wherein the measuring sensor measures at least one of an oxygen concentration, a pH value, an ammonium concentration, or an ammonia concentration.

20. The arrangement of claim 10, wherein the material contains plant leaf polymers from dead and dropped autumn leaves.
